(19) United States
(12) Patent Application Publication
(10) Pub. No.: US 2011/0273832 A1
(43) Pub. Date: Nov. 10, 2011

(54) Access Door For A Mobile Computing System

(76) Inventors: Mark S. Tracy, Tomball, TX (US); Paul J. Doczy, Austin, TX (US); Earl Moore, Cypress, TX (US)

(21) Appl. No.: 13/142,481

(22) PCT Filed: Dec. 30, 2008
(86) PCT No.: PCT/US2008/088537

§ 371 Date: Jun. 28, 2011

(51) Int. Cl. G06F 1/16

(52) U.S. Cl. 361/679.31; 361/679.02; 361/679.58; 361/679.55

(57) ABSTRACT

An access door for a mobile computing system. At least some of the illustrative embodiments are systems comprising a chassis of a computing system, a peripheral device mounted within the chassis, an access door that at least partially defines a surface of the chassis, the access door has a first orientation that at least partially hides the peripheral device, and a second orientation that exposes at least a portion of the peripheral device, and a communication port on the access door.

### BACKGROUND

A Mobile computing system (e.g., a notebook computer or a Personal Digital Assistant (PDA)) may comprise peripheral devices (e.g., a CD-ROM or a hard disk drive) that perform various functions related to the mobile computing system. In some cases, one or more of the peripheral devices may be removable from the mobile computing system. For example, the mobile computing system may comprise a removable hard disk drive to enable sharing of the information on the hard disk drive with relative ease.

### BRIEF DESCRIPTION OF THE DRAWINGS

For a detailed description of exemplary embodiments, reference will now be made to the accompanying drawings in which:

FIG. 1A shows a mobile computing system in accordance with some embodiments;

FIG. 1B shows a mobile computing. system in accordance with some embodiments;

FIG. 2 shows a cross-sectional view of an access door in accordance with some embodiments;

FIG. 3 shows an access door in accordance with some embodiments;

FIG. 4 shows an access door in accordance with some embodiments; and

FIG. 5 shows an access door in accordance with some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

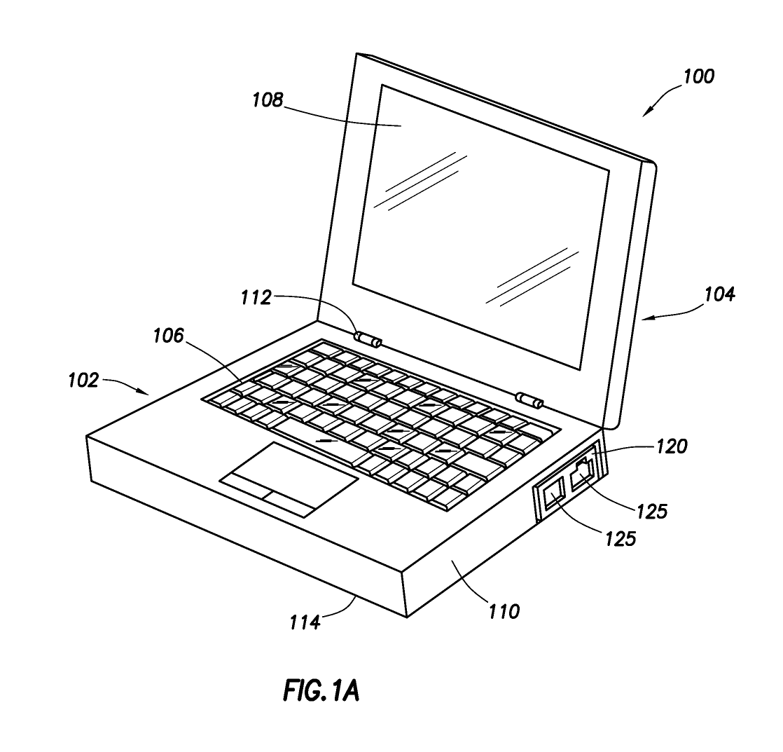

FIG. 1A shows an illustrative mobile computing system 100 in accordance with at least some of the embodiments. The mobile computing system 100 comprises a first chassis 102 and a second chassis 104. The first chassis 102 couples to the second chassis by way of hinges 112. The first chassis 102 comprises a user interface, such as a keyboard 106. So that the information may be conveyed to a user, the second chassis 104 of the mobile computing system 100 comprises a display screen 108. In at least some of embodiments, the mobile computing system 100 comprises various peripheral devices that reside at least partially within the mobile computing system 100. For example, the peripheral devices may be devices such as hard disk drives, optical disk drives (e.g., CD-ROM), or memory card readers.

In related art mobile computing systems, access to a peripheral device is provided by either an access panel on the bottom surface of a chassis or an access door on the side surface of the chassis. Providing access to the peripheral device by the access panel on the bottom surface may increase the risk of damage from compressive forces. Likewise, providing access to the peripheral devices by the access door on the side surface reduces the space on the side surface for communication ports.

In accordance with the various embodiments, an access door 120 with a communication port 125 provides access to a peripheral device residing within the mobile computing system 100. In the embodiments of FIG. 1A, access door 120 defines a side surface 110 of the first chassis 102. However, the access door 120 may define any surface of the mobile computing system 100 at any suitable location on the mobile computing system 100. For example, the access door 120 may be placed at any location of the first chassis 102, such as the front surface, the back surface or the side surfaces. In alternative embodiments, the access door 120, along with the peripheral device, may be placed at any location within the second chassis 104. For example, the access door 120 may be placed along a side surface of the second chassis 104 proximate to the display screen 108. In other embodiments, the access door 120 may be placed along other locations of the second chassis 104 such as the front surface or the back surface. The embodiments of FIG. 1A illustrate the access door 120 in a first orientation that at least partially hides the peripheral device mounted within the mobile computing system 100. In some embodiments, the first orientation of the access door 120 may be equivalently referred to as a closed orientation.

In at least some embodiments, the access door 120 comprises various communication ports 125 that enable communication with the mobile computing system 100. For example, the communication ports 125 may be ports such as Universal Serial Bus (USB) ports, IEEE 1394 ports, or RJ-45 style Ethernet ports. The access door 120 may comprise any number of communication ports 125, and any combination of communication ports 125. For example, the access door 120 may comprise a single Ethernet port or a combination of an Ethernet port with a USB port.

FIG. 1B illustrates the access door 120 in a second orientation. In particular, the second orientation of the access door 120 exposes at least a portion of the peripheral device 130 (e.g., a hard disk drive or an optical disk drive) visible through an aperture 135 of the first chassis 102. In some embodiments, the second orientation of the access door 120 may be equivalently referred to as an open orientation. In some embodiments, the access door 120 comprises a locking mechanism 140 that securely retains the access door in the first orientation (FIG. 1A). The locking mechanism 140 mates with a corresponding locking mechanism on the first chassis 102. In some embodiments, when the access door 120 is in the second orientation, the peripheral device 130 may be removed from the first chassis 102. Consider, for purpose of explanation, that the peripheral device 130 is a hard disk drive, then the hard disk drive mounted within the first chassis may be removed and replaced with another similar hard disk drive. In at least some embodiments, a flexible cable 145 communicatively couples the communication ports on the access door 120 with a system board (e.g., a motherboard) within first chassis 102.

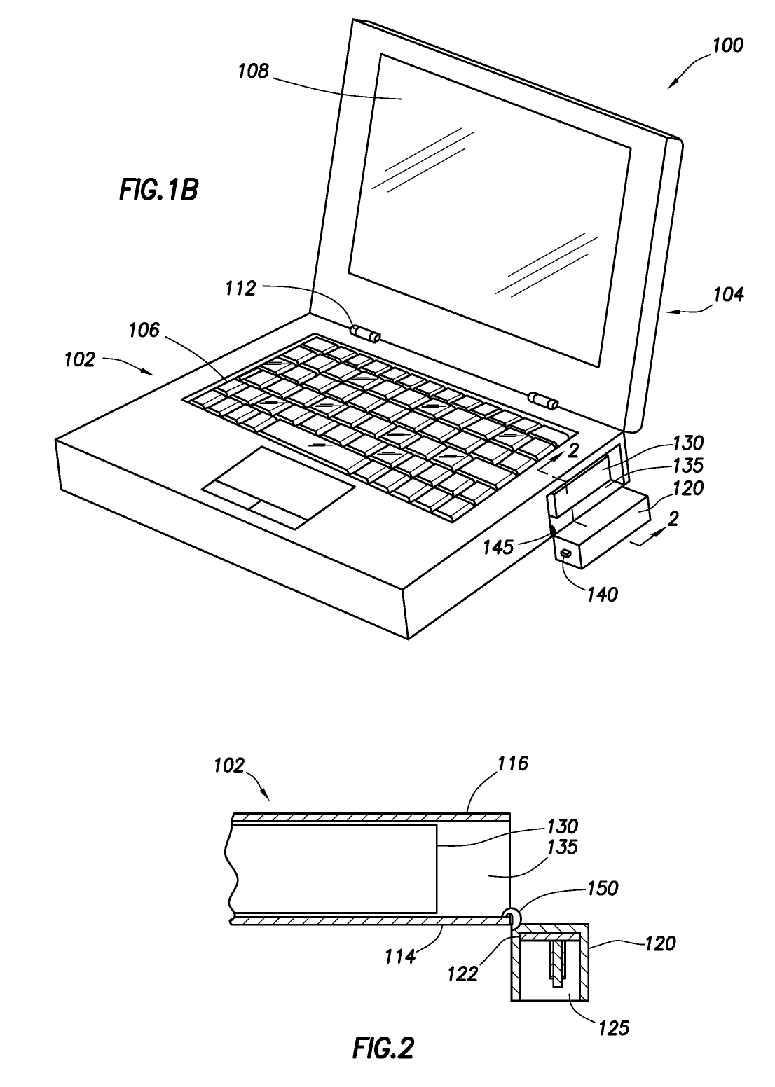

FIG. 2 illustrates a cross-sectional view taken substantially along the line 2-2 of FIG. 1 B. In particular, FIG. 2 illustrates a peripheral device 130 residing within the first chassis 102. The access door 120 is in the second orientation that at least partially exposes the peripheral device 130 through the aperture 135. Communication port 125 on the access door 120 enables communication with the mobile computing system 100. In some embodiments, the access door 120 comprises a printed circuit board 122 with the communication port 125 that is communicatively coupled with a system board within the first chassis 102. In the particular embodiment, the access door 120 is coupled near the bottom surface 114 of the first chassis 102 by way of a hinge mechanism 150. In other embodiments, the access door is coupled near the top surface 116 of the first chassis by way of a hinge mechanism 150. The hinge mechanism 150 enables pivoting of the access door 120 between the first orientation (FIG. 1) and the second orientation. In some embodiments, the hinge mechanism 150 is a spring loaded hinge mechanism 150.

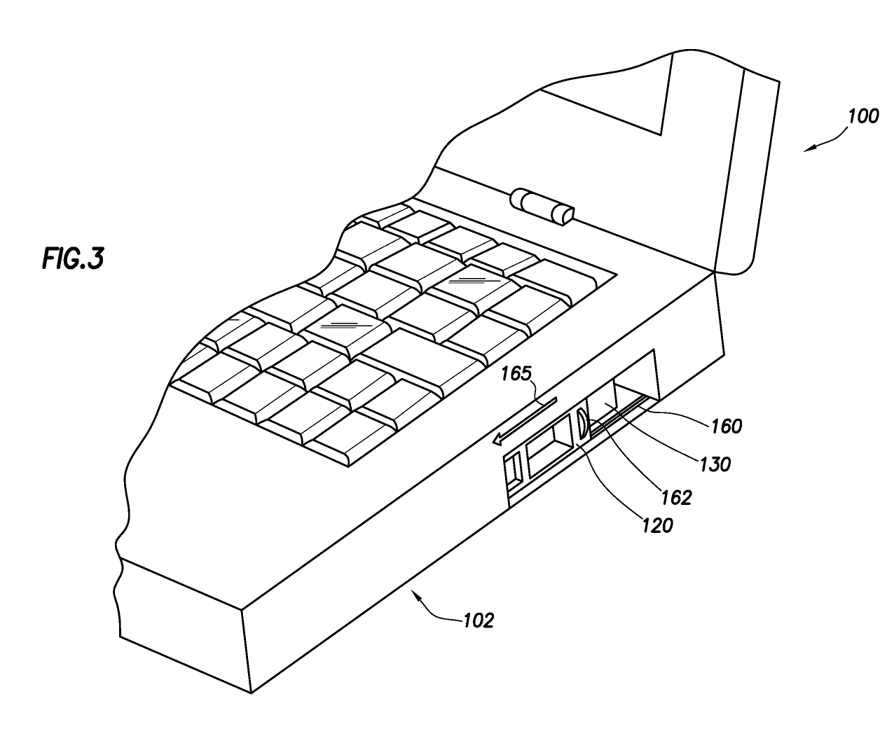

FIG. 3 illustrates an alternative embodiment of the access door 120. In particular, FIG. 3 illustrates the access door 120 coupled to the first chassis 102 by way of a sliding mechanism 160 (e.g., sliding tracks). In some embodiments, an individual may utilize a handle 162 on the access door 120 to slide the access door 120 along the sliding mechanism 160. Sliding the access door 120 in the direction indicated by the arrow 165 positions the access door in the second orientation that exposes the peripheral device 130. While sliding the access door 120 in the direction opposite to the direction of the arrow 165 positions the access door 120 in the first orientation that at least partially hides the peripheral device 130. In some embodiments, a locking mechanism (e.g., a latch) may be utilized to securely retain the access door 120 in the first orientation or the second orientation.

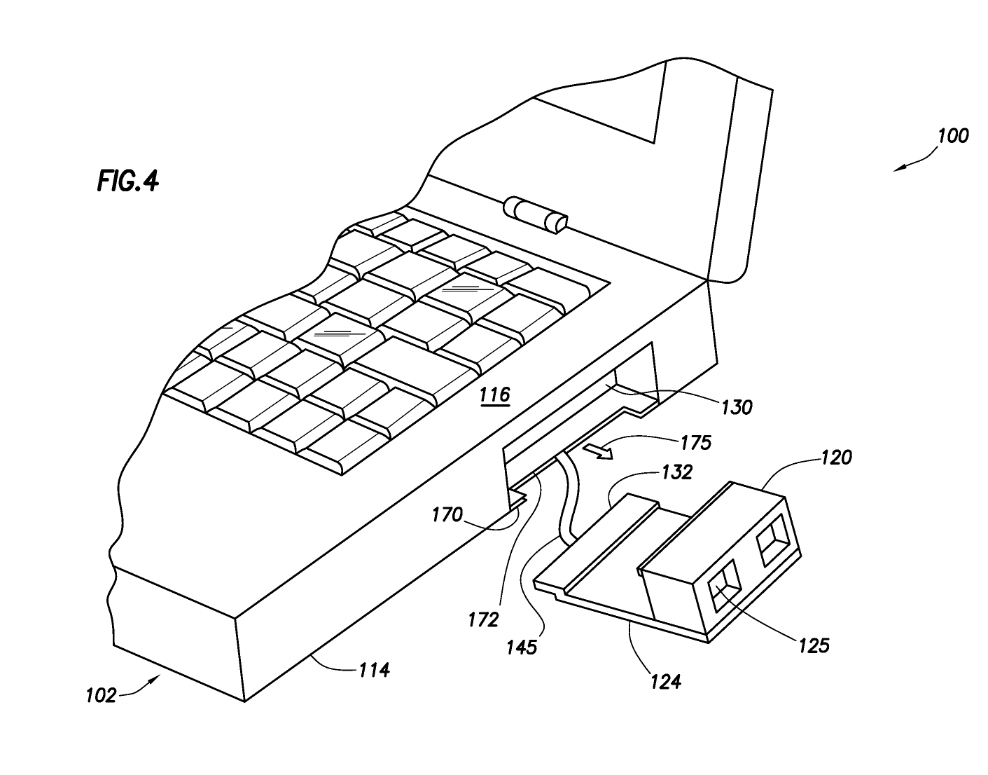

FIG. 4 illustrates another embodiment of the access door 120. In particular, FIG. 4 illustrates an access door 120 that couples to the first chassis 102 by way of a sliding mechanism 170. In the particular embodiment, the sliding mechanism 170 comprises a slot opening 172 that defines the bottom surface 114 of the first chassis 102. In other embodiments, the slot opening 172 may define the top surface 116 of the first chassis 102. The access door 120 slides in the direction indicated by the arrow 175 to at least partially expose the peripheral device 130. In the particular embodiment of FIG. 4, the access door 120 is fully removed from the slot opening 172 to expose the peripheral device 130. When the access door 120 is telescoped within the slot opening 172, the access door 120 is in the first orientation that at least partially hides the peripheral device 130, and the bottom surface 124 of the access door 120 defines the same plane as the bottom surface 114 of the first chassis. A flexible cable 145 communicatively couples the communication ports 125 on the access door 120 to the system board within the first chassis 102. In other embodiments, the access door 120 may comprises a connector situated at an end 132 of the access door 120 to communicatively couple the access door 120 to the system board within the chassis.

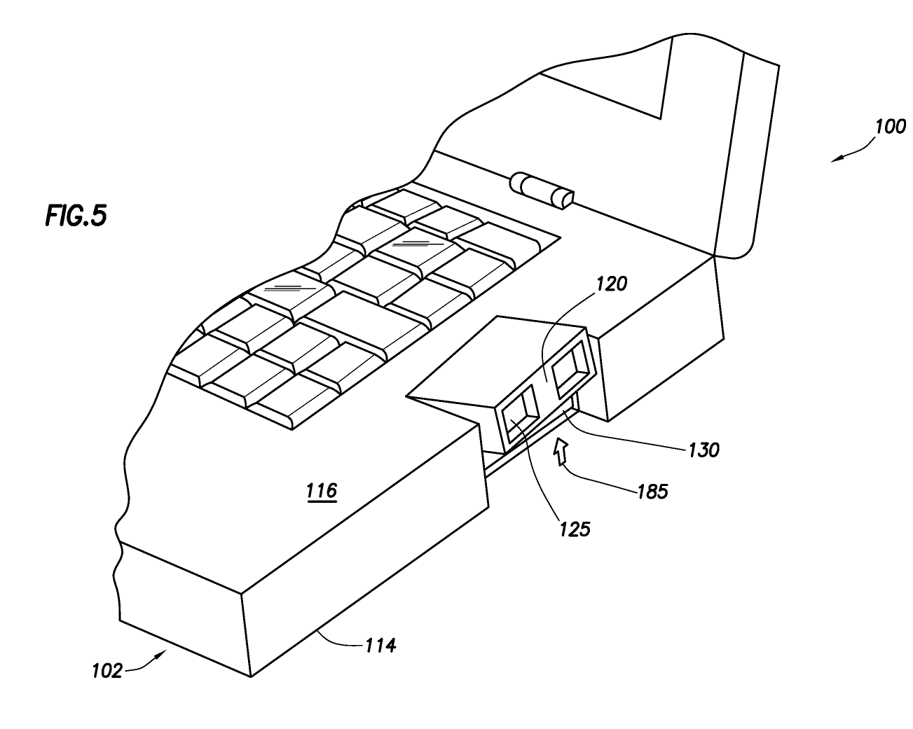

FIG. 5 illustrates yet still another embodiment of the access door 120. In particular, the access door 120 is depressed to release the access door 120 from a closed orientation (FIG. 1). In embodiments of FIG. 5, the access door 120 moves in a direction indicated by the arrow 185 to at least partially expose the peripheral device 130. The access door 120 may also move in a direction opposite to the direction of the arrow 185 to hide the peripheral device 130 (i.e., the second/closed orientation). In the particular embodiment of FIG. 5, the access door 120 is Coupled near the top surface 116 of the first chassis 102 by way of a hinge mechanism. In other embodiments, the access door 120 may be coupled near bottom surface 114 of the first chassis 102 by way of the hinge mechanism.

In accordance with the various embodiments, the peripheral device 130 is coupled to the system board within the mobile computing system. For example, if the peripheral device is a hard disk drive, then an Integrated Drive Electronics (IDE) connector may be utilized to couple the hard disk drive to the system board. In some embodiments, the peripheral device 130 is telescoped within a peripheral carrier device that is mounted within the mobile computing system 100. The peripheral carrier device reduces the risk of damage to the peripheral device from compressive forces experienced by mobile computing system 100.

The above discussion is meant to be illustrative of the principles and various embodiments of the present invention. Numerous variations and modifications will become apparent to those skilled in the art once the above disclosure is fully appreciated. For example, the mobile computing system may be any mobile computing system such as a mobile telephone, a personal digital assistant (PDA), a camera or any other mobile computing system. Moreover, the mobile computing system 100 may comprise only a first chassis including a user interface, such as a touch screen, a pointer device, a keyboard. It is intended that the following claims be interpreted to embrace all such variations and modifications.

What is claimed is:

1. A system comprising:
a chassis of a computing system;
a peripheral device mounted within the chassis;
an access door that at least partially defines a surface of the chassis, the access door has a first orientation that at least partially hides the peripheral device, and a second orientation that exposes at least a portion of the peripheral device; and
a communication port on the access door.

2. The system as defined in claim 1 wherein the surface of the chassis is a side surface of the chassis.

3. The system as defined in claim 1 wherein the access door comprises a printed circuit board configured to couple the communication port to a system board within the chassis.

4. The system as defined in claim 1 further comprises a flexible cable configured to couple the communication port to a system board within the chassis.

5. The system as defined in claim 1 wherein the system further comprises a locking mechanism configured to retain the access door in the first orientation.

6. The system as defined in claim 1 wherein the least one communication port is at least one selected from the group consisting or: a Universal Serial Bus (USB) port; an IEEE 1394 port; and an Ethernet port.

7. The system as defined in claim 1 wherein the access door is coupled to the side surface of the chassis by way of at least one selected from the group consisting of: a hinge mechanism; and a sliding mechanism.

8. A mobile computing system comprising:
a peripheral device mounted within a chassis of the mobile computing system;
an access door that at least partially defines a surface of the mobile computing system, the access door has a first orientation that at least partially hides the peripheral device, and a second orientation that exposes at least a portion of the peripheral device, and
a communication port on the access door, the communication port communicatively coupled to the mobile computing system.

9. The mobile computing system as defined in claim 8 wherein the access door further comprises a printed circuit board configured to communicatively couple the communication port to the mobile computing system.

10. The mobile computing system as defined in claim 8 further comprises a flexible cable configured to communicatively couple the communication port to the mobile computing system.

11. The mobile computing system as defined in claim 8 wherein the mobile computing system further comprises a locking mechanism configured to retain the access door in the first orientation.

12. The mobile computing system as defined in claim 8 wherein the peripheral device is at least one selected from the group consisting of: a hard disk drive; a optical disk drive; and a memory card reader.

13. A system comprising:
a means for providing access to a peripheral device mounted within a chassis of a mobile computing system, the means for providing access at least partially defines a surface of the chassis; and
a means for communicating with the mobile computing system mounted on the means for providing access.

14. The system as defined in claim 13 wherein the means for providing access further comprises a printed circuit board configured to couple the communication port to the mobile computing system.

15. The system as defined in claim 13 further comprising a means for locking the means for providing access to the mobile computing system.
